(19) United States
(12) Patent Application Publication
(10) Pub. No.: US 2013/0257743 A1
(43) Pub. Date: Oct. 3, 2013

(54) Insect Repelling Digital Photo Frame with Biometrics

(71) Applicant: Yat Wai Edwin Kwong, Causeway Bay (HK)

(72) Inventor: Yat Wai Edwin Kwong, Causeway Bay (HK)

(21) Appl. No.: 13/432,352

(22) Filed: Mar. 28, 2012

(51) Int. Cl. G06F 3/041

(52) U.S. Cl. 345/173

(57) ABSTRACT

A photo frame and method for repelling insects, displaying pictures based on location, and selectively displaying the pictures based on current physical holders of users is provided. The photo frame's components include an outer frame, a touch display, a fingerprint reader, an anti-mosquito component, a location detection device, a camera, a processor and a memory. Users of the photo frame are able to digitally interact with the frame by way of biometrics technology. The biometrics employed by the present technology include fingerprint reading and facial recognition technology. Using a fingerprint reader and camera, the photo frame captures and stores users' fingerprint and photographs on provided memory. The photo frame is configured to identify returning users and display photos associated with them. The photo frame uses ultrasonic wave emission to repel mosquitos.

### FIELD OF THE INVENTION

This invention is generally related to systems and methods for displaying pictures. More specifically, this invention is related to a portable outdoor photo displaying device that utilizes biometrics and insect repelling components.

### BACKGROUND OF THE INVENTION

In the past, captured memories in the form of photographs were stored in physical albums. Recently, technology has provided digitized photography. A standalone digital camera is a well-known and preferred form of photography. Unlike film cameras, digital cameras take digital images or videos and store them directly in internal memory or a memory card. Digital images are typically stored in a JPEG format (file extension “.jpg”). JPEG images are compatible with most personal computers and can be viewed, printed, and shared.

Numerous other devices are capable of reading and displaying digital images. A recent innovation has been the digital photo frame. These devices come in multiple shapes and sizes. They generally employ a liquid crystal display (“LCD”) screen capable of displaying photographs. They usually require a USB cable or memory card input in order to display photographs.

In the past, digital photo frames were used in indoor applications; such as within stores or homes. However, there does not exist many digital photo frames that are made for outdoor, public use. Moreover, in many climates mosquitos have become a necessary evil of participating in outdoor activities. A storefront or amusement park operator may wish to have patrons view digital photos for an extended period of time. The existence of mosquitos which potentially carry malaria can dissuade people from standing still in front of a digital photo frame. Moreover, patrons are more likely to view a digital display for a longer period of time if the display is active, and not passive. This means that the user can interact with display.

As per digital photo frames for personal use, a user may wish to view digital photographs in an outdoor environment at night. The light from the LCD screen may easily attract mosquitos and other insects. This surely will dissuade a user from bringing their digital photo frame to places to show friends and family.

As a result, in view of the foregoing, there is a need unfulfilled in the art for devices and methods that enable outdoor interactive digital photograph viewing without the worry of insects and pests.

### SUMMARY OF THE INVENTION

According to embodiments of the invention, a photo frame for repelling insects, displaying pictures based on location, and selectively displaying the pictures based on current physical holders of the photo frame is provided. The photo frame's components include an outer frame, a touch display, a fingerprint reader, an anti-mosquito component, a location detection device, a camera, a processor and a memory. The fingerprint reader and camera are disposed along the outer frame. The camera is capable of employing facial recognition software to photograph and identify users. The location detection device facilitates the display of photos based on the real-time geographic location of the photo frame. The anti-mosquito component is capable of emitting ultrasonic waves to repel mosquitos.

The memory comprises instructions that cause the processor to execute a method which comprises the following steps. The first step involves registering one or more users of the photo frame upon initial use of each user. This step involves: a) recording fingerprints of the users of the photo frame; b) capturing a photo of the faces of the users; and c) associating data regarding each of the users with their respective faces and fingerprints. The associated data may include age or any other identifying characteristics.

The next step involves entering a display mode which comprises the following steps. First, detecting a fingerprint of a current user of the frame, wherein the detection is made using the fingerprint reader. Then detecting a face of the current user and displaying a picture of the user.

The method proceeds with the photo frame entering into anti-mosquito mode. While in anti-mosquito mode, the photo frame uses the associated data regarding the detected user and detected current location of frame to initiate emission of mosquito repelling waves. Furthermore, the frame adjusts the intensity of the ultrasonic waves based on the associated data and location.

In embodiments of the disclosed invention, the steps of entering display mode and entering anti-mosquito mode are performed contemporaneously.

In another embodiment of the disclosed technology, a photo frame for repelling insects, displaying pictures based on location, and selectively displaying the pictures based on current physical holders of the photo frame is provided. The photo frame's components include an outer frame, a touch display, a fingerprint reader, an anti-mosquito component, a location detection device, a camera, a processor and a memory. The fingerprint reader and camera are disposed along the outer frame. The camera is capable of employing facial recognition software to photograph and identify users. The anti-mosquito component is capable of emitting ultrasonic waves to repel mosquitos. The memory comprises fingerprint data and facial recognition data regarding one or more of a plurality of preregistered users. In this embodiment, the identifying data such as fingerprints, photos and biographical data may be preconfigured on the device.

The memory further comprises instructions that cause the processor to execute a method comprising the following steps. The first step involves entering a display mode. Display mode entails detecting a fingerprint of the current user of the frame using the fingerprint reader, detecting a face of the current user and displaying a picture of the current user. If the face of the user is not recognized, a registration process is initiated. The registration process involves: a) recording the fingerprints of the user; b) capturing a photo of the face of the user; and c) gathering personal data associated with the user.

The method may further comprise an additional step of entering an anti-mosquito mode. The anti-mosquito mode involving emission of ultrasonic waves. The intensity of the waves may be adjusted based on the personal data regarding the user. The intensity of the waves may also take into account the detected location of the photo frame as detected by the location detection device. Moreover, in an additional step, a photo associated with the detected location may be displayed on the photo frame.

In still another embodiment of the disclosed technology, an outdoor photo frame is provided. The photo frame comprises a display housed within an outer frame, a fingerprint reader, a camera, a memory, a processer, a location detection device, and an anti-mosquito component. The fingerprint reader is disposed on the surface of the outer frame and is configured to record, store, and recognize fingerprints of a plurality of users. The camera is likewise disposed on the outer frame, and is configured to record and store images of users. The camera is further configured to employ facial recognition software in order to identify a returning user. The facial recognition software, as well as the images and fingerprints, are stored on the memory. The processor carries out the fingerprint reading and facial recognition. The location detection device is capable of detecting the real-time location of the photo frame, and may also display a photo depending on the detected location. The ant-mosquito component emits ultrasonic waves for repelling nearby mosquitos.

In further embodiments, the processor may be configured to display an image of a user upon recognition of the user by the fingerprint reader. In another embodiment, the display may be a touch display by which a user may input personal data to be associated with that user's fingerprints and photograph. In this embodiment, the intensity of the emitted ultrasonic waves may be based on the personal data of the current user and/or the detected location of the frame.

In accordance with these and other objects which will become apparent hereinafter, the invention will now be described with particular reference to the drawing.

### BRIEF DESCRIPTION OF THE DRAWINGS

FIG. 1 shows a front elevation view of a photo frame according to embodiments of the disclosed invention.

### DETAILED DESCRIPTION

According to embodiments of the invention, a photo frame and method for repelling insects, displaying pictures based on location, and selectively displaying the pictures based on current physical holders of users is provided. Users of the photo frame are able to digitally interact with the frame by way of biometrics technology. Biometrics generally involves personal security and identification by way of unique human characteristics, the measurement of which is sufficient to identify a single human being. The biometrics employed by the present technology include fingerprint reading and facial recognition technology. Using a fingerprint reader and camera, the photo frame captures and stores users' fingerprint and photographs on provided memory. The photo frame is configured to identify returning users and display photos associated with them. The photo frame uses ultrasonic wave emission to repel mosquitos.

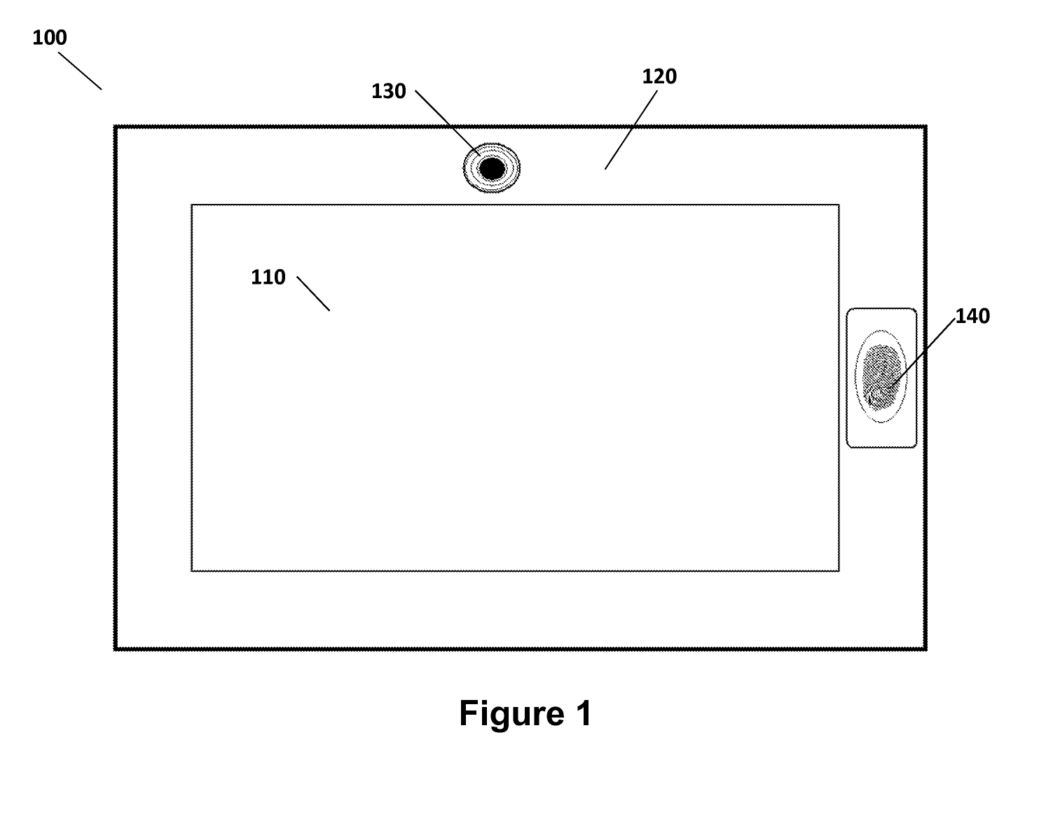

Referring now to the drawings, FIG. 1 shows a front elevation view of a photo frame according to embodiments of the disclosed invention. The photo frame 100 is shown. The photo frame's 100 components include an outer frame 120, a display 110, a fingerprint reader 140, an anti-mosquito component, a location detection device, a camera 130, a processor and a memory. The fingerprint reader 140 and camera 130 are disposed along the outer frame 120. The camera 130 is capable of employing facial recognition software to photograph and identify users. The location detection device facilitates the display of photos based on the real-time geographic location of the photo frame 100. The anti-mosquito component is capable of emitting ultrasonic waves to repel mosquitos.

Referring still to FIG. 1, the memory comprises instructions that cause the processor to execute a method which comprises the following steps. The first step involves registering one or more users of the photo frame upon initial use of each user. This step involves: a) recording fingerprints of the users of the photo frame; b) capturing a photo of the faces of the users; and c) associating data regarding each of the users with their respective faces and fingerprints. The associated data may include age or any other identifying characteristics.

The next step involves entering a display mode which comprises the following steps. First, detecting a fingerprint of a current user of the frame, wherein the detection is made using the fingerprint reader. Then detecting a face of the current user and displaying a picture of the user.

The method proceeds with the photo frame entering into anti-mosquito mode. While in anti-mosquito mode, the photo frame uses the associated data regarding the detected user and detected current location of frame to initiate emission of mosquito repelling waves. Furthermore, the frame adjusts the intensity of the ultrasonic waves based on the associated data and location.

In embodiments of the disclosed invention, the steps of entering display mode and entering anti-mosquito mode are performed contemporaneously.

In another embodiment of the disclosed technology, a photo frame for repelling insects, displaying pictures based on location, and selectively displaying the pictures based on current physical holders of the photo frame is provided. The photo frame's components include an outer frame, a touch display, a fingerprint reader, an anti-mosquito component, a location detection device, a camera, a processor and a memory. The fingerprint reader and camera are disposed along the outer frame. The camera is capable of employing facial recognition software to photograph and identify users. The anti-mosquito component is capable of emitting ultrasonic waves to repel mosquitos. The memory comprises fingerprint data and facial recognition data regarding one or more of a plurality of preregistered users. In this embodiment, the identifying data such as fingerprints, photos and biographical data may be preconfigured on the device.

The memory further comprises instructions that cause the processor to execute a method comprising the following steps. The first step involves entering a display mode. Display mode entails detecting a fingerprint of the current user of the frame using the fingerprint reader, detecting a face of the current user and displaying a picture of the current user. If the face of the user is not recognized, a registration process is initiated. The registration process involves: a) recording the fingerprints of the user; b) capturing a photo of the face of the user; and c) gathering personal data associated with the user.

The method may further comprise an additional step of entering an anti-mosquito mode. The anti-mosquito mode involving emission of ultrasonic waves. The intensity of the waves may be adjusted based on the personal data regarding the user. The intensity of the waves may also take into account the detected location of the photo frame as detected by the location detection device. Moreover, in an additional step, a photo associated with the detected location may be displayed on the photo frame.

In still another embodiment of the disclosed technology, an outdoor photo frame is provided. The photo frame comprises a display housed within an outer frame, a fingerprint reader, a camera, a memory, a processer, a location detection device, and an anti-mosquito component. The fingerprint reader is disposed on the surface of the outer frame and is configured to record, store, and recognize fingerprints of a plurality of users. The camera is likewise disposed on the outer frame, and is configured to record and store images of users. The camera is further configured to employ facial recognition software in order to identify a returning user. The facial recognition software, as well as the images and fingerprints, are stored on the memory. The processor carries out the fingerprint reading and facial recognition. The location detection device is capable of detecting the real-time location of the photo frame, and may also display a photo depending on the detected location. The ant-mosquito component emits ultrasonic waves for repelling nearby mosquitos.

In further embodiments, the processor may be configured to display an image of a user upon recognition of the user by the fingerprint reader. In another embodiment, the display may be a touch display by which a user may input personal data to be associated with that user's fingerprints and photograph. In this embodiment, the intensity of the emitted ultrasonic waves may be based on the personal data of the current user and/or the detected location of the frame.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A photo frame for repelling insects, displaying pictures based on location, and selectively displaying the pictures based on current physical holders of the photo frame, comprising:
an outer frame;
a touch display;
a fingerprint reader disposed on the perimeter of the frame;
an anti-mosquito component that produces ultrasonic waves for repelling mosquitos;
a location detection device for facilitating the display of photos based on a detected location;
a camera disposed in the frame, the camera operable to employ facial recognition software;
a processor; and
a memory storing instructions that cause the processor to execute a method comprising the following steps:
registering one or more users of the photo frame upon initial use of each user, the registration comprising:
recording fingerprints of the users of the photo frame;
capturing a photo of the faces of the users; and
associating data regarding each of the users with their respective faces and fingerprints;
entering a display mode after initial use, the display mode comprising:
detecting a fingerprint of a current user of the frame, wherein the detection is made using the fingerprint reader; and
detecting a face of the current user and displaying a picture of the user;
entering anti-mosquito mode, the anti-mosquito mode comprising:
using the associated data regarding the detected user and detected current location of frame to initiate emission of mosquito repelling waves and to adjust the intensity of the ultrasonic waves based on the associated data and location.

2. The method of claim 1, wherein said steps of entering display mode and entering anti-mosquito mode are performed contemporaneously.

3. The method of claim 1, wherein the associated data for a detected user comprises the user's age in order to determine intensity of ultrasonic waves.

4. A photo frame for repelling insects, displaying pictures based on location, and selectively displaying the pictures based on current physical holders of the photo frame, comprising:
an outer frame;
a touch display;
a fingerprint reader disposed on the perimeter of the frame;
an anti-mosquito component that produces ultrasonic waves for repelling mosquitos;
a location detection device;
a camera disposed in the frame, the camera operable to employ facial recognition software;
a processor; and
a memory, the memory comprising fingerprint data and facial recognition data regarding one or more of a plurality of preregistered users;
the memory further comprising instructions that cause the processor to execute a method comprising the following steps:
entering a display mode, the display mode comprising:
detecting fingerprint of current user of the frame, wherein the detection is made using the fingerprint reader;
detecting face of current user and displaying a picture of the user;
if the face of the user is not recognized, initiating a registration process, the registration process comprising:
recording of fingerprints of the user;
capturing a photo of the face of the user; and
gathering personal data associated with the user.

5. The photo frame of claim 4, wherein the method further comprises the following steps:
entering an anti-mosquito mode, the anti-mosquito mode comprising:
initiating production of mosquito repelling waves; and
adjusting the intensity of the ultrasonic waves based on the personal data regarding the user.

6. The photo frame of claim 5, wherein the step of adjusting the intensity of the ultrasonic waves also takes into account a detected location of the photo frame as detected by the location detection device.

7. The photo frame of claim 6, wherein the method further comprises a step of displaying a photo associated with a current location of the photo frame as detected by the location detection device.

8. An outdoor photo frame comprising:
a display housed within an outer frame;
a fingerprint reader disposed on the surface of the outer frame, the finger print reader configured to record, store and recognize fingerprints of a plurality of users;
a camera disposed on a surface of the outer frame, the camera configured to record and store images of a plurality of users, and to recognize a returning user using facial recognition software;
a memory for storing the fingerprints of users, images of users, and facial recognition software;
a processor for carrying out the fingerprint reading and the facial recognition;
a location detection device capable of detecting real-time location of the photo frame; and
an anti-mosquito component that produces ultrasonic waves for repelling of nearby mosquitos.

9. The outdoor photo frame of claim 8, wherein the processor is configured to exhibit an image of a user upon recognition of the user by the fingerprint reader.

10. The outdoor photo frame of claim 8, wherein the processor is configured to exhibit an image based on the detected real-time location of the photo frame.

11. The outdoor photo frame of claim 8, wherein the display is a touch display.

12. The outdoor photo frame claim 11, wherein the memory further comprises personal data inputted by one or more of said plurality of users via the display.

13. The outdoor photo frame of claim 12, wherein the anti-mosquito component is configured to adjust the intensity of the ultrasonic waves based on the personal data of a current user.

14. The outdoor photo frame of claim 8, wherein the anti-mosquito component is configured to adjust the intensity of the ultrasonic waves based on the detected real-time location of the photo frame.
